(19) United States
(12) Patent Application Publication
(10) Pub. No.: US 2020/0063440 A1
(43) Pub. Date: Feb. 27, 2020

(54) SMART FLOOR TILES AND SMART FLOOR SYSTEMS

(71) Applicant: AMBIT MICROSYSTEMS (SHANGHAI) LTD., Shanghai (CN)

(72) Inventor: YU-HU YAN, New Taipei (TW)

(21) Appl. No.: 16/109,704

(22) Filed: Aug. 22, 2018

(51) Int. Cl. E04F 15/02; H04B 1/38

(52) U.S. Cl. CPC E04F 15/02; H04W 84/18; H04B 1/38

(57) ABSTRACT

A smart floor tile capable of gathering environmental information and sensing the local presence of a body includes a tile body, an engagement interface, a processor, a storage device, and a sensing element. The engagement interface physically engages with another tile body. The processor generates local coordinate information according to received coordinate information and can output its own local coordinate information through the connection interface. The storage device stores the local coordinates of each smart floor tile. The sensing element is coupled to the processor and can transmit data to a server as to transient events experienced, and each smart floor tile can also be controlled to output audible, visible, and haptic effects from outputting elements contained within the smart floor tile.

### FIELD

The subject matter herein generally relates to smart floor tiles and systems.

### BACKGROUND

The position of a user indoors can be detected through gyroscopes, accelerometers, or orientation sensors in a mobile device held by the user. However, the accuracy of the positioning is limited by the precision of the sensors, and the mobile device must be carried by the user.

Therefore, there is room for improvement within the art.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a block diagram of a smart floor tile according to an embodiment of the disclosure;

FIG. 2 is a schematic view of the engagement interface in a smart floor tile according to an embodiment of the disclosure;

FIG. 3 is a schematic view showing the assignment of coordinates using a smart floor system according to an embodiment of the disclosure;

FIG. 4A is a schematic view of the smart floor tiles according to an embodiment of the disclosure;

FIG. 4B is a cross-sectional view of a connection part between tiles shown in FIG. 4A according to an embodiment of the disclosure; and

FIG. 5 is a block diagram of a smart floor system according to an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

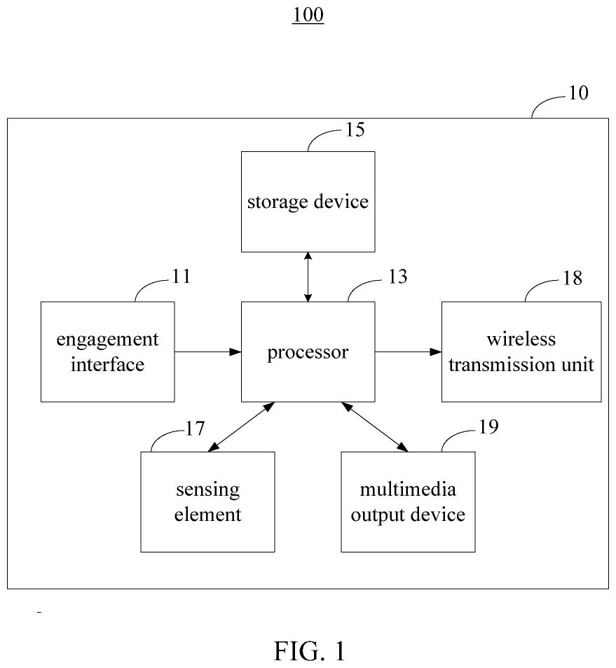

FIG. 1 is a block diagram of a smart floor tile according to an embodiment of the disclosure. The smart floor tile 100 according to an embodiment of the disclosure comprises a tile body 10, an engagement interface 11, a processor 13, a storage device 15, a sensing element 17, a wireless transmission unit 18, and a multimedia output device 19. The engagement interface 11 is disposed on an edge or in an internal space of the tile body 10.

In an embodiment of the disclosure, the material of the tile body 10 may be wood, acrylic, glass, or other materials. The engagement interface 11 can be used to physically engage with another tile body (not shown in this figure). Where the tile body 10 is a quadrilateral shape as an example, the engagement interface 11 can be disposed on four sides of the tile body 10. The type of the engagement interface 11 can be a Universal Synchronous Asynchronous Receiver/Transmitter (USART), Universal Asynchronous Receiver/Transmitter (UART), RS-232, Universal Serial Bus (USB), Serial Peripheral Interface Bus (SPI), Inter-Integrated Circuit (I2C), or Transistor-transistor logic (TTL).

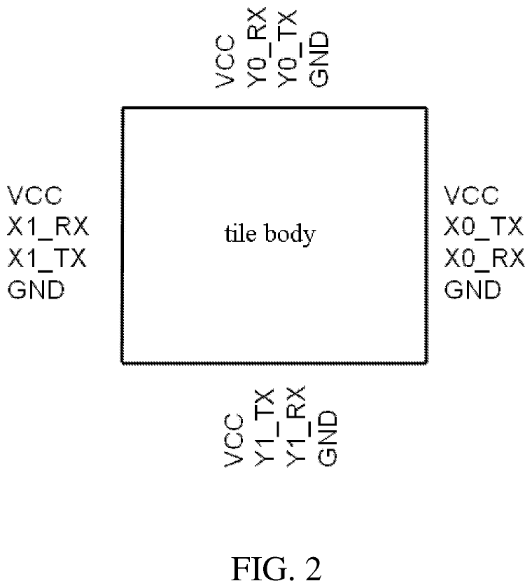

FIG. 2 is a schematic view of the engagement interface 11 according to an embodiment of the disclosure. Using UART interface as an example, four UART interfaces (X0_RX, X0_TX), (X1_RX, X1_TX), (Y0_RX, Y0_TX) and (Y1_RX, Y1_TX) are disposed on four sides of the tile body 10 and share power terminals (VCC, GND). The smart floor tile 100 receives coordinates and other information of other smart floor tiles through the engagement interface 11. The tile body 10 shown in FIG. 2 is quadrilateral shaped and the engagement interface 11 comprises four UART interfaces. However, the tile body 10 may be other shapes, such as triangular, circular, and other polygons, and the type and number of the engagement interfaces 11 may also be designed according to actual needs without being limited to the content disclosed in FIG. 2. In an embodiment, the engagement interface 11 further comprises engagement structures (not shown) for engaging with other tile body 10.

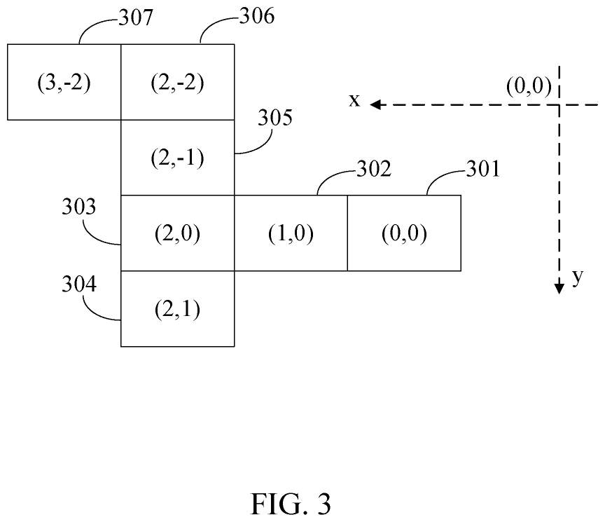

The processor 13 generates local coordinate information according to the coordinate information received from the engagement interface 11 of an adjacent smart floor tile 100 through the engagement interface 11 and the position engaged with the adjacent smart floor tile. The local coordinate information is output through the engagement interface 11 to another smart floor tile 100. FIG. 3 shows the assignment of coordinates using the smart floor system according to an embodiment of the disclosure. Taking the left direction in the figure as positive for the x-axis and the downward direction in the figure as positive for the y-axis, the smart floor tile 301 is a reference smart floor tile, which provides reference local coordinate information (0, 0). Other smart floor tiles 302-307 have no local coordinate information before engaging with smart floor tile 301. When the smart floor tile 302 is engaged with the smart floor tile 301, the smart floor tile 301 transmits its reference local coordinate information (0, 0) to the smart floor tile 302 through the engagement interface. The processor of the smart floor tile 302 can determine that the smart floor tile 302 is positioned on the positive x-axis direction of the smart floor tile 301 according to the engagement position, and can generate its own local coordinate information (1, 0) according to the coordinate information (0, 0) received from the smart floor tile 301. Similarly, the processor of the smart floor tile 303 can make a determination that the smart floor tile 303 is itself positioned on the positive x-axis direction of the smart floor tile 302 according to the engagement position. The smart floor tile 303 can generate its own local coordinate information (2, 0) according to the coordinate information (1, 0) received from the smart floor tile 302. The respective processors of smart floor tiles 304-307 can make similar progressive determinations. Finally, local coordinate information of the smart floor tile 306 (2, −2), and local coordinate information of the smart floor tile 307 (3, −2) are obtained in the same manner. Thus, the coordinates information of the entire smart floor system is assigned.

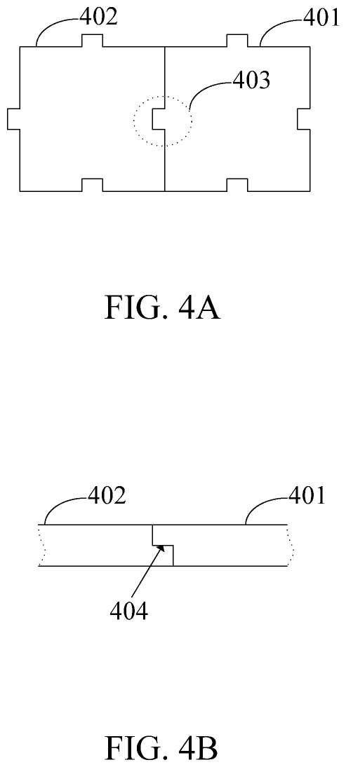

FIG. 4A shows the smart floor tiles according to an embodiment of the disclosure. As shown in FIG. 4A, the joint 403 of the tile bodies 401 and 402 at the engagement interface comprises bumps and corresponding grooves. Thereby, the tile bodies 401 and 402 can be attached accurately and conveniently. FIG. 4B shows the connection part between the tiles shown in FIG. 4A according to an embodiment of the disclosure. The joint 403 of the tile bodies 401 and 402 further comprises electrical contacts for transmitting data.

Referring to FIG. 1, the storage device 15 stores the local coordinate information. In other embodiment, the storage device 15 further stores information as to size of the tile body 10. The entire surface area of the smart floor can be obtained according to the sizes information of the tile bodies 10.

The sensing element 17 is coupled to the processor 13 for detecting environmental information or touches and generates sensing signals accordingly. The sensing element 17 may comprise sensors for detecting environmental information, such as that of thermometers, barometers, hygrometers, odor sensors, air quality monitors, and smoke detectors, etc. The sensing element 17 may also comprise sensors for detecting presence of humans, such as by pressure sensors, contact sensors, and behavior detectors.

The sensing information generated by the sensing element 17 can be analyzed by the processor 13, and can be transmitted to other smart floor tiles 100 or a remote server. In other embodiment, the smart floor tile 100 may comprise a wireless transmission unit 18 for transmitting the sensing signals generated by the sensing elements 17 and the local coordinate information to the remote server.

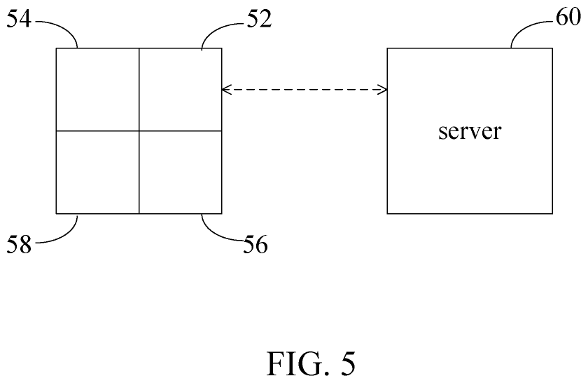

FIG. 5 shows a smart floor system according to an embodiment of the disclosure. In this embodiment, the smart floor tiles 52, 54, 56, and 58 are identical to the smart floor tile 100 of FIG. 1, the detailed operations and structures of those are as disclosed previously. In another embodiment, the smart floor tiles 52, 54, 56, and 58 may also have increased or decreased specific functional elements as required. Four smart floor tiles are shown in FIG. 5, but the number is not limited to this, and the user can configure an appropriate number of smart floor tiles according to actual needs. As shown in FIG. 5, the smart floor tiles 52, 54, 56, and 58 are connected, and the local coordinate information of the smart floor tiles 52, 54, 56, and 58 is obtained as above. The smart floor tiles 52, 54, 56, and 58 may communicate with the server 60 through wired or wireless protocols. In an embodiment, the smart floor tiles 52, 54, 56, and 58 may transmit the sensing information of the sensing element and local coordinate information directly to the server 60 and receive data or control signals of the server 60 through the wireless transmission unit 18 (shown in FIG. 1). In another embodiment, the smart floor tiles 52, 54, 56, and 58 may transmit the sensing information of the sensing element and the local coordinate information to the server 60 and receive data or control signals of the server 60 through their interconnected engagement interfaces. For example, the smart floor tile 54 can output the sensing information and the local coordinate information via its engagement interfaces, the smart floor tile 52 can receive the sensing information and the local coordinate information of the smart floor tile 54 through the engagement interface connected to the smart floor tile 54, and tile 52 can output the sensing information and the local coordinate information of the smart floor tile 54 to the server 60 through the engagement interface connected to the server 60.

The server 60 generates information mapped to the local coordinate information of the smart floor tiles 52, 54, 56, and 58. The map information may comprise the locations and the sizes of the smart floor tiles 52˜58. In an embodiment, the server 60 may obtain the surface area of the entire smart floor according to the sizes information of the smart floor tiles 52˜58. In another embodiment, the storage devices of the smart floor tiles 52˜58 may store data of the smart floor tiles by reference to identification numbers. For example, the data of each floor tile may comprise floor area, material, and types of sensing elements carried.

In the embodiment shown in FIG. 3, the coordinate information is composed of two values, that is the coordinate information includes the x-axis coordinate value and the y-axis coordinate value. In other embodiments, the coordinate information may comprise three values. The first two values are still the x-axis coordinate and the y-axis coordinate values. The third value may represent regional information of the smart floor tiles. In an embodiment, the third value may represent the location of each smart floor tile in different regions. For example, the coordinate information of the smart floor tiles located in the living room on the first floor may be (x, y, 1), those located in the balcony on the first floor may be (x, y, 2), and those located in the bedroom on the second floor may be (x, y, 3). Referring to FIG. 5, the third value of the coordinate information can be set by user through the user interface of the server 60 and stored in the storage unit 15 of the smart floor tile. In another embodiment, the coordinate information may comprise a fourth value for representing the size information of the smart floor tile.

In an embodiment, the smart floor tiles 52˜58 may each comprise a multimedia output device 19 (shown in FIG. 1). The multimedia output element 19 may be a sound output element, a light output element, or a tactile generator. The sound output element may be a speaker for playing sounds. The light output element may emit a specific color of light or display a predetermined light pattern. The tactile generator can produce vibrations. The server 60 generates a control instruction according to the sensing information generated by the sensing elements 17 and the local coordinate information of the smart floor tiles 52˜58, and can control the multimedia output element 19 of a predetermined smart floor tile to output audible, visible, or haptic effects using the control instruction.

According to the embodiments of the disclosure, the user can quickly create the indoor mapping and coordinates according to the engagement relationship among the smart floor tiles. In addition, the environmental information can be collected and the location of a user walking on the tiles can be sensed, and a specific multimedia effect can be provided.

Many details are often found in the art such as the other features of smart floor tiles. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A smart floor tile comprising:
a tile body;
an engagement interface disposed on an edge of the tile body and physically engaged with another tile body;
a processor, generating local coordinate information according to received coordinate information and the position engaged with the another tile body, and outputting the local coordinate information through the engagement interface;
a storage device storing the local coordinate information; and
a sensing element coupled to the processor, detecting environmental information or touches to generate a sensing signal.

2. The smart floor tile of claim 1, wherein the processor outputs the sensing information through the engagement interface.

3. The smart floor tile of claim 1, further comprising a wireless transmission unit for transmitting the sensing information and the local coordinate information.

4. The smart floor tile of claim 1, wherein the storage device further stores size information of the tile body.

5. The smart floor tile of claim 1, wherein the storage device further stores region information of the tile body.

6. The smart floor tile of claim 1, further comprising a multimedia output device for outputting multimedia information according to a control instruction.

7. A smart floor system comprising:
a first floor tile comprising:
a first tile body;
a first engagement interface disposed on an edge of the first tile body;
a first processor providing first coordinate information through the first engagement interface;
a first storage device storing the first local coordinate information; and
a first sensing element coupled to the first processor, detecting environmental information or touches to generate a first sensing signal;
a second floor tile comprising:
a second tile body;
a second engagement interface disposed on an edge of the second tile body, and physically engaged with the first engagement interface;
a second processor receiving the first local coordinate information through the first engagement interface and the second engagement interface, generating second local coordinate information according to the first local coordinate information and the location of the second tile body engaged with the first tile body, and outputting the second local coordinate information through the second engagement interface;
a second storage device storing the second local coordinate information; and
a second sensing element coupled to the second processor, detecting the environmental information or the touches to generate a second sensing signal; and
a server generating map information according to the first local coordinate information and the second local coordinate information.

8. The smart floor system of claim 7, wherein the first floor tile outputs the first sensing information through the first engagement interface, the second floor tile receives the first sensing information through the second engagement interface, and outputs the first sensing information and the first coordinate information to the server through the second engagement interface.

9. The smart floor system of claim 7, wherein the first floor tile further comprises a wireless transmission unit for transmitting the first sensing information and the first local coordinate information to the server.

10. The smart floor system of claim 7, wherein the first storage device further stores first size information of the first floor tile, the second storage device further stores second size information of the second floor tile, and the server further generates the map information according to the first size information and the second size information.

11. The smart floor system of claim 7, wherein the first storage device further stores first region information of the first floor tile, the second storage device further stores second region information of the second floor tile, and the server sets the first region information and the second region information according to a user input information.

12. The smart floor system of claim 7, wherein the first floor tile further comprises a first multimedia output device, the second floor tile further comprises a second multimedia output device, and the first multimedia output device and the second multimedia output device output multimedia information according to a control instruction.

13. The smart floor system of claim 12, wherein the server provides the control instruction to control the first multimedia output device or the second multimedia output device outputting the multimedia information.
